(19) United States
(12) Patent Application Publication
(10) Pub. No.: US 2002/0049576 A1
(43) Pub. Date: Apr. 25, 2002

(54) Digital and analog mixed signal simulation using PLI API

(76) Inventor: Steven J. Meyer, Mill Valley, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/899,763

(22) Filed: Jul. 5, 2001

Related U.S. Application Data
(60) Provisional application No. 60/216,065, filed on Jul. 5, 2000.

(51) Int. Cl. G06F 17/50

(52) U.S. Cl. 703/14; 703/4

(57) ABSTRACT

A system and method for analog and digital mixed mode simulation. The system and method simulates analog mixed signal (AMS) systems coded in one or a plurality of hardware description languages (HDLs) that describe digital subsystem, analog circuits, and mixed signal interface components. It implements and simulates AMS circuits using any standardized and specialized type of application programming interface (API) called a HDL programming language interface (PLIs). In it preferred embodiment, the system and method simulates systems coded in the popular Verilog-AMS HDL and legacy Spice HDLs. Utilization of the PLI allows for a much simplified and improved AMS simulation because the mixed mode engine implemented using the PLI invokes any commonly available digital simulator(s) for the digital engine(s) and any commonly available analog solver(s) for the analog engine(s). The system and method combines the accuracy of single kernel AMS simulation with the ease of construction and flexibility of data exchange AMS simulation.

### CLAIM TO PRIORITY

The present application claims priority to U.S. Provisional Application No. 60/216,065, filed Jul. 5, 2000 and entitled “Digital and Analog Mixed Signal Simulating Using PLI API.” The identified provisional application is hereby incorporated by reference.

### BACKGROUND OF THE INVENTION

1. Field of the Invention

The present invention generally relates to a simulation method and apparatus, and in particular, a method for simulating analog digital, and mixed signal (AMS) electronic systems coded in Hardware Description Languages (HDLs). AMS simulation is sometimes called mixed mode simulation. The present invention also relates to the area of simulation program implementation utilizing a specialized software application programming interface (API) called an HDL programming language interface (PLI). More specifically, the present invention relates to the area of combining digital binary logic value event driven simulation and analog differential equation solving circuit simulation. The system and method of the present invention is used in verifying semiconductor integrated circuits in the field of electronic computer aided design (ECAD).

2. Description of Prior Art

The popularity of consumer electronics has resulted in large electronic systems that combine both analog and digital subsystems. Such systems are often implemented using only one integrated circuit (IC) called a system on a chip (SoC). This popularity in consumer electronics accompanied by increases in IC component capacity has resulted in a need for automatic verification of analog mixed signal (AMS) circuits.

I. Obsolete AMS Simulation Methods

A number of methods for AMS system verification (per standard usage, the terms mixed signal, mixed mode and the abbreviation AMS are used interchangeably) have been disclosed that attempted to solve the mixed signal simulation problem by translating analog circuits into digital components or by translating digital components into analog circuits. These methods are obsolete because either the digital or analog modeling accuracy is lost or because analog to digital (AtoD) and digital to analog (DtoA) interfaces are not modeled at all.

The following U.S. patents disclose translation from analog to digital AMS simulation methods. U.S. Pat. No. 5,297,066, entitled “Digital Circuit Simulation of Analog/Digital Circuits”, simulates analog components by using a cell library that defines analog components in digital terms. Analog values are represented as digital bit vectors giving all possible voltage levels. The method is limited to simplified analog models because analog circuit equations are not solved. U.S. Pat. No. 5,105,373, entitled “Method of Simulating the Operation of a Circuit Having Analog and Digital Circuit Parts”, defines a method for simulating the analog portion of a circuit using separate computer code (functions). These functions are called by the digital simulator. The procedures model analog components using either tables or transfer functions. However, again, analog modeling is inaccurate. U.S. Pat. No. 5,991,522, entitled “Method and Apparatus for Circuit Conversion for Simulation, Simulator Using the Same, and Computer-Readable Medium with a Program Therefor Stored Thereon”, discloses a conversion method for converting analog components to a circuit suitable for digital only simulation.

II. Current AMS Verification Methods

The most common AMS system verification method operates to verify digital and analog subsystems separately. The digital components and the analog components are modeled separately and then combined blindly into completed mixed signal systems. Any incorrect assumptions about the analog to digital interface, digital to analog interface, and power or electrical interaction requires another time consuming and expensive design iteration. As such, this method is essentially no mixed signal verification method at all.

A newer mixed signal verification method uses simulation to verify AMS systems. The two most popular AMS simulation methods are: 1. single kernel AMS simulation; and 2. separate digital and analog simulation with mixed signal data exchange.

II.A. Single Kernel AMS Simulation

In the single kernel method, the AMS simulator is written from scratch, or written by starting with a digital simulation source code and an analog simulation source code and rewriting these source codes into an integrated mixed mode simulator. The simulator uses a common circuit information data base that stores both analog and digital information. The mixed signal interfaces, such as analog to digital (AtoD) and digital to analog (DtoA) conversion, is implemented using the common circuit data base and is tightly integrated into the one simulation kernel. The single kernel method usually results in an AMS simulator with inferior pure digital and pure analog simulation because each type of simulator alone takes many years of development. However, the single kernel method usually has a very good mixed signal modeling capability because the digital and analog simulation computer program routines are tightly coupled. Another disadvantage of the single kernel method results from the large differences in the type of information that must be stored for digital versus analog simulation. The digital information is discrete and is stored as small integers or bits while the analog information is represented by real values that are usually stored in multi-dimensional matrices.

The following U.S. patents disclose methods related to single kernel simulation. U.S. Pat. No. 4,985,860, entitled “Mixed-Mode-Simulator Interface”, defines a method for synchronizing analog wave forms and digital time that rolls back analog time when needed. The '860 Patent assumes that an AMS simulator exists and discloses only a method for synchronizing time. U.S. Pat. No. 5,394,346, entitled “Simulation of an Electronic System Including Analog and Digital Using High Level Macro Models”, discloses a single kernel simulation method wherein analog elements are modeled by high level analog macros and digital elements are modeled by high level digital macros. The macros are constructed by extracting layout data and converting that data to tables or analog transfer functions. Analog circuits are only modeled in the frequency domain and are simulated using inaccurate repeated approximations, but the accuracy is better than simulators that translate analog elements into digital primitives. Simulation is single kernel because the circuit properties are repeatedly extracted and used as inputs for other high level macros for which repeated approximations are made. Results of the approximations are then used to re-extract circuit properties. The '346 Patent does not disclose a method for general mixed signal simulation.

II.B. Data Exchange AMS Simulation

In the disjoint digital and analog simulation with data exchange method, standardized analog and digital simulators are used in stand alone mode. AMS simulation is accomplished by sending discrete simulation results converted to real values from the digital simulator to the analog simulator and sending analog real values, such as voltage levels converted to logic levels, to the digital simulator. One or more of the following methods for exchanging information between programs provided by computer operating systems are used: shared files, pipes, semaphores, shared memory, thread execution, and remote procedure calls.

This data exchange method results in good digital and good analog simulation since the best available simulators can be selected for use in the mixed signal simulation. However, the separate simulation with data exchange method provides inferior mixed signal interface verification. Because the analog and digital simulators are not tightly coupled, information exchange is usually limited to circuit boundary elements (usually called input ports or output ports), and time synchronization is coarse grained. The lack of tight coupling results in the two most serious limitations of decoupled mixed signal simulation. First, it is not possible to represent a mixed signal system using one unified hardware description language (HDL) such as Verilog-AMS or VHDL-AMS HDLs that are now undergoing standardization. Second, it is not possible to model subtle interactions between digital and analog circuit portions that arise in deep sub micron circuit design. For modern deep sub micron circuits, decoupled mixed signal simulation is not much better than separated pure digital and pure analog simulation. Finally, the disjointed data exchange method does not allow automatic mixed signal interface element insertion because the digital simulator has no knowledge of the analog portion of the circuit and the analog simulator has no knowledge of the digital portion of the circuit.

The following U.S. patents disclose data exchange AMS simulation methods. U.S. Pat. No. 4,792,913, entitled “Simulator for Systems Having Analog and Digital Portions”, describes a method that uses data extraction and file sharing to communicate analog node values to a digital simulator and to communicate digital signal values to an analog simulator. U.S. Pat. No. 5,481,484, entitled “Mixed Mode Simulation Method and Simulator”, executes analog and digital simulation alternately and extracts the digital current that is used by the analog simulation. This method improves analog circuit simulation accuracy by extracting digital analyzed circuit portion current usage. It also improves data exchange by using computer programs to convert analog information before sending it to a digital simulator and to convert digital information before sending it to an analog simulator. However, this method suffers from the limitation that data transfer and synchronization is determined during simulator implementation. The data transfer and synchronization cannot be coded by the user or dynamically changed using earlier simulation results. U.S. Pat. No. 5,822,567, entitled “Method of and Apparatus for Simulating Integrated Circuit”, is a method for speeding up separate analog parts of digital and analog simulation by using a controller that determines when analog circuit simulation can be avoided. The method of the '567 Patent suffers from the limitation that the controller does not allow data exchange. Rather, the controller only controls interleaving of separate digital and analog simulators.

III. Digital Simulation

Digital design and verification is quite well understood and automated within the art. Digital systems are described using standardized HDLs such as Verilog (IEEE P1364 standard) or VHDL (IEEE P1076 standard). Digital circuits are modeled using a small number of discrete values (usually 4 values but sometimes 12 or 128 to model signal strengths). Digital behavior is modeled using fast, event driven methods. Although other types of digital simulation such as levelized unit delay simulation, cycle-based simulation, or hardware accelerated simulation are also sometimes utilized. The semantics of digital behavior is widely understood and standardized. Digital systems are described at the gate level using net lists and at the behavioral level using register transfer level (RTL) descriptions.

IV. Analog Simulation

Analog circuit simulators, such as SPICE, have been used in analog circuit design and verification for decades. Analog design and verification is less well understood than digital design and verification because analog simulation requires the solving of sets of differential equations that describe transistor behavior. Since the solution of differential equations is computatively intensive, only small parts of analog systems can be simulated. Analog designers must then guess at analog system behavior from numerous small circuit simulators. Analog simulation is also less standardized and less automated than digital simulation because there are many approaches to solving circuit differential equations and there are many different analog circuit properties that need to be simulated. The most common of these properties are voltage, current and frequency.

Analog circuits are also described using HDLs but the descriptions, until recently, have been limited to coding low level transistor elements and wire interconnections. The most popular analog HDL is called SPICE. SPICE is the de facto standard defined originally by “Spice 2: A Computer Program to Simulate Semiconductor Integrated Circuits”, L. W. Nagel, UCB/ERL M520, May 1975. In SPICE circuits, interconnections are coded by using bodies that are electrical nodes and transistor behaviors are coded by using predefined models of fabrication processes. The nodes and process models are translated into differential equations and simulated by solving the resulting sets of differential equations. Analog circuit simulation uses real number values to describe node electrical characteristics such as voltage, whereby the real number values may be viewed as continuous waveforms via oscilloscope traces.

Because solving systems of partial differential equations is time consuming, other less accurate simulation methods such as polynomial interpolation or translation to digital components (transfer functions) are sometimes used. A newer HDL coding and simulation method describes analog circuits by defining and solving the differential equations that describe analog circuit behavior directly thereby eliminating the step of translating from circuit nodes to differential equations.

V. Mixed Signal Simulation

AMS system simulation and verification is even less well understood and automated than analog verification. In general, the mixed signal interface part of AMS simulation defines methods for converting analog voltages or currents to discrete digital logic values (a process called analog to digital conversions using elements called AtoDs) and methods for converting discrete digital logic values to analog voltages or currents (a process called digital to analog conversions using elements called DtoAs). The mixed signal part of AMS simulation also defines methods for synchronizing analog continuous time and discrete tick digital time.

VI. Mixed Signal HDLs

Recently, HDLs that allow coding entire mixed signal designs have been developed. These languages are defined as additions or enhancements to the standardized digital HDLs. The current most popular AMS language is Verilog-AMS. Another AMS language is VHDL-AMS. Standardization of both languages is currently in progress. AMS HDLs add various new constructs to digital HDLs. Among the added constructs are: analog blocks for coding analog circuit sections as equations, global signal property sections (called nature and discipline definitions in Verilog-AMS) that allow for user-definitions of analog circuit properties to model (properties only need follow basic circuit properties such as Kirkoff's laws), voltage and current nodes for declaring circuit voltage and current nodes, and branches for describing connections between nodes (see FIG. 1 for a prior art Verilog-AMS example).

In the case of the Verilog-AMS HDL, except for global natures and disciplines, AMS additions are defined inside HDL modules so that digital HDL instance tree structures are preserved in AMS HDLs. Some AMS HDLs also define other additions such as non-native language inclusions constructs for including other HDLs (currently primarily used to include SPICE subcircuits in AMS HDL models). HDLs may also include constructs for defining global nodes to model power and ground nodes and global parameters to define global fabrication process related parameters. Other language sections become AMS HDL modules and instances, again preserving the HDL instance structure that allows subsystems to be designed and verified independently.

VII. HDL PLI Description

HDL PLIs allow linking programs written in common programming languages, such as C, to be compiled into one or a plurality of object libraries that are then linked with elaborated HDL system models just before simulation begins. Any programming language code, such as a SPICE simulation engine, can be included in PLI programs. HDL definitions define the names, functions, and actual parameters of program language routines that user-PLI programs call to interact with the HDL simulator.

The advantage of PLI APIs is that they are standardized and documented in great detail so that any number of different PLI programs can be developed to add additional functionality, such as implementation of mixed signal simulation, to basic electronic simulators. Because PLIs define table driven program linking standards, different organizations can develop PLI extensions that will inter-operate because of PLI standardization. Computer program code is reusable because it uses common APIs and will not interfere with other PLI applications because of the standardized PLI initialization call back mechanisms.

In the system and method of the present invention, the final AMS mixed mode simulation program is the result of the linking together of one or more a digital simulation engines, one or more analog simulation engines, and all mixed mode analog to digital converter (AtoD) routines and all mixed mode digital to analog converter (DtoA) routines along with glue computer program code, which is described in detail within the “preferred embodiment” section of the present application, that calls the PLI routines. Computer program linking is well understood in the prior art. There are many different methods for linking various different computer programs and routines into an executable program. Those methods of linking range from simple combining of object modules using a linker to dynamically loading an entire executable program during execution using dynamic link system calls, e.g., dlopen, dlsym, etc.

All the various programs and routines that make up the AMS mixed mode simulation program and method of the present invention are preferably linked via a new simulator binary program that itself can then have user PLI programs linked in with it, i.e., it has all the capabilities of the normal digital simulation engine plus the added mixed mode simulation engine as described herein below. In order to understand this AMS simulation system and method, it is necessary to understand the prior art of how HDL PLIs work.

For example, in Verilog the routine vpi_register_cb is used to register a user program function (called a call back) that is called by the HDL simulator when a specified event happens such as the change of a wire. It takes a PLI defined record called a cb_data structure as its one argument. HDL PLIs are very similar to other APIs that for example allow middle ware to be used with computer operating systems and electronic simulators.

HDL PLIs define at least five basic routine classes:

1. Routines that register call backs—

Call backs allow HDL simulators to call a user program routine when a particular event happens, such as: 1. a particular system task executed ($pli_memory_model in FIG. 1): 2. a net or variable change (for example to monitor every time an output of a particular instance changes); 3. a simulation related event occurs (for example when simulation time reaches 1000).

2. Routines that access values—

HDL system model values are read using value access routines. In Verilog, the routine is called vpi_get_value. This routine reads the value of any object that has a value. For example, the routine may read the value that a system task recently returned (if the task is active) or a value that will be returned (if the task is active).

3. Routines that assign values—

HDL system model values are written using value setting routines. In Verilog, the routine is called vpi_put_value. Values are normally written to nets and registers after a given delay has elapsed.

4. Routines that allow access to HDL constructs—

HDL source constructs access routines allow determination of exact details of HDL circuit description. In Verilog, the one-to-one HDL construct access routine is named vpi_handle and the one-to-many access routine is named vpi_iterate. For example, vpi_iterate is used to access all ports for a given instance. Vpi_handle is used to access instance connections to a port called vpiHighConn or port connections inside a module called vpiLowConn. Most HDLs allow complete HDL source reconstruction using PLI access routines.

5. Routines that allow delay reading and writing—

HDL delays are read and written using the PLI delay routines. In Verilog, the routine vpi_get_delays is used to read delays and vpi_put_delays is used to set delays.

PLI delay reading and writing is normally used before simulation begins.

An HDL simulator is informed that one or a plurality of user PLI programs must be loaded and executed with a predefined table of call back routines that the simulator reads when it begins running if the table has been linked into the simulator binary object code. If no PLI routines exist, the predefined table is empty. If many different PLI programs are used during an HDL simulation there will normally be one start up call back routine in the predefined table for each PLI application.

The Verilog PLI is defined more completely in the “IEEE Std. 1364-1995 Verilog Hardware Description Language Reference Manual.” IEEE Standards Board. Chap 17-23, IEEE; New York, 1996. This manual is hereby incorporated by reference in its entirety.

### SUMMARY OF THE INVENTION

The present invention comprises one or more digital simulators, one or more analog simulators, and a mixed signal computer program that controls simulation and synchronizes discrete digital time with continuous analog time. The analog mixed signal (AMS) simulation system and method of the present invention is used to simulate designs coded in hardware description languages (HDLs). The present invention combines any one of many commonly available digital hardware description language (HDL) simulators with any one of many commonly available analog HDL simulators to simulate analog mixed signal circuits (normally called AMS circuits) is disclosed. The system and method of the present invention uses programming language interfaces (PLI) that are a specialized kind of application programming language interface (API) to perform AMS simulation. The invention can be conceptualized as a complex multiple “engine” machine. The digital simulation engine performs discrete digital event simulation. The analog simulation engine simulates analog components by solving circuit description differential equations. The mixed signal engine acts as an interface between the other engines by reading data, writing data, scheduling changes, monitoring for changes and coordinating discrete digital time with continuous analog time.

Because PLIs are defined for all modern HDLs, the mixed signal engine consists of computer code that functions by making calls to the various PLI API library routines. This invention is made possible by the existence of standardized APIs for HDLs that allow user application specific computer procedures to be linked with simulation computer program object code to produce application specific enhanced simulation programs. PLIs allow mixed signal functionality (mixed signal engine) to be developed separately from simulation program development. PLIs are also commonly available and usually standardized so that simulators can be mixed and matched depending on choice of brands of digital and analog simulators. Yet, using well understood computer program and library linking the result of development is still one computer program that implements the AMS simulation invention.

The system and method of the present invention allows independent development and selection of both digital event and analog circuit simulators. The present invention can be embodied with legacy different analog and digital HDLs. An embodiment using the most popular HDLs would combine the Verilog digital HDL with the Spice analog HDL. The present invention's preferred embodiment uses new unified syntax, standardized AMS languages such as Verilog-AMS where both analog and digital circuits are coded in the same HDL. These unified languages have the advantage of allowing user definition of mixed signal interfaces.

Within the present invention, PLI routines are called by the mixed signal engine to allow discrete digital values to be converted to continuous analog node values for use in analog simulation (called AtoD conversion) and to convert continuous analog node values to discrete digital logic values (called DtoA conversion) for use in digital simulation. The present invention is used to verify not only analog and digital circuit function but also to accurately model and verify increasingly more common interactions between analog and digital system components. The present invention also allows AMS simulation where analog simulation uses non-standard circuit properties such as frequency domain simulation of high frequency wireless circuits.

The present invention that is disclosed herein provides advantages over the two most popular current mixed signal simulation methods. With respect to the unified kernel approach, the present invention provides the advantage of allowing the use of off the shelf digital and analog simulators while preserving the fine granularity of a unified kernel. With respect to disjoint or decoupled simulation with data exchange, the present invention provides the advantage of tightly coupled simulation using standardized PLI APIs.

The present invention allows efficient simulation because the HDL PLIs it uses have been designed for efficiency, although in most cases, the mixed signal efficiency is overshadowed by the time required to solve analog differential equations. An additional advantage of the present invention is that the same HDL PLIs used to construct the invention can be utilized by the user of the invention to add other simulation functionality. Examples of possible added user PLI functionality are: user PLI programming to monitor AtoD converter voltage margins during AMS simulation, or user PLI programming to model, at an abstract functional level digital components for which detailed design is not yet completed.

The present invention is general purpose because it works with any HDL, and any digital simulator brand of the HDL. In addition, it works with any equation solving method used by analog simulators (usually called solver engines). The present invention provides the most advantages when the one or more HDLs and their associated PLIs are standardized (as is now common practice usually as an IEEE and/or ISO standard) so that many different simulator brands are available in the market. In the invention's preferred embodiment, one combined AMS HDL is used that allows mixed signal interfaces to be coded by users inside the HDL and allows one unified instance tree to be coded.

The system and method of the present invention results in one PLI enhanced computer program that is constructed by linking together one or more selected analog simulators, one or more selected digital simulators, and by adding a number of additional computer program routines that implement information exchange and coordination of the other components by means of the PLI (called the mixed signal program or engine). The system and method of the present invention then comprises three types of functional components (usually called engines): 1) analog simulation engines 2) digital simulation engines, and 3) mixed signal engines. In invention's preferred embodiment, the executable program is the mixed signal engine core. The remainder of HDL simulators and mixed signal procedures are dynamically loaded during execution using dynamic linking, spawning of processes, or spawning of threads depending on the operation of the computer that executes the mixed signal engine core. In alternative embodiments of the present invention, the simulation program is statically linked using a linker, or linked using dynamic libraries with parallel execution implemented using OS provided mechanisms.

The present invention works best with any standardized digital simulator, e.g., the Verilog simulator standardized by the IEEE P1364 (ref. 1995 IEEE P1364 Verilog Language Reference Manual or the IEEE P1364 Verilog 2000 Language Reference Manual standard) and associated PLI. The present method also works best with any standardized AMS simulator such as the standardized IEEE Verilog P1364-AMS HDL combining both digital and analog modeling HDL constructs with analog HDL constructed defined as a variant of the IEEE digital Verilog P1364 standard (ref. in draft state IEEE P1364-AMS Verilog AMS Language reference Manual). The present invention also works with any analog HDL, including the currently most popular analog HDL called Spice.

### BRIEF DESCRIPTION OF THE DRAWINGS

FIG. 1 is prior art showing example of mixed signal circuit coded in the Verilog-AMS HDL.

FIG. 2 is a flowchart showing mixed signal system design flow made possible by the present invention.

FIG. 3 is a flowchart showing an overview of the AMS mixed signal simulation system and method of the present invention. It shows the relationships between the analog, digital and mixed signal simulation engines.

FIG. 4 is a flowchart showing digital and analog elaboration steps.

FIG. 5 is a flowchart showing elaboration for a simplified alternative embodiment using only one AMS HDL.

FIG. 6 is a flowchart showing the steps in AMS interface elaboration that are completed after digital and analog elaboration.

FIG. 7 is a flowchart showing the steps in AMS simulation set up.

FIG. 8 is a flowchart showing the PLI controlled AMS simulation steps.

FIG. 9 sections 9.24 and 9.25 from the Verilog-AMS LRM draft 1.5, which define an AMS synchronization method.

FIG. 10 is a block diagram of an example computer system that may be used to realizing the system and method of the present invention.

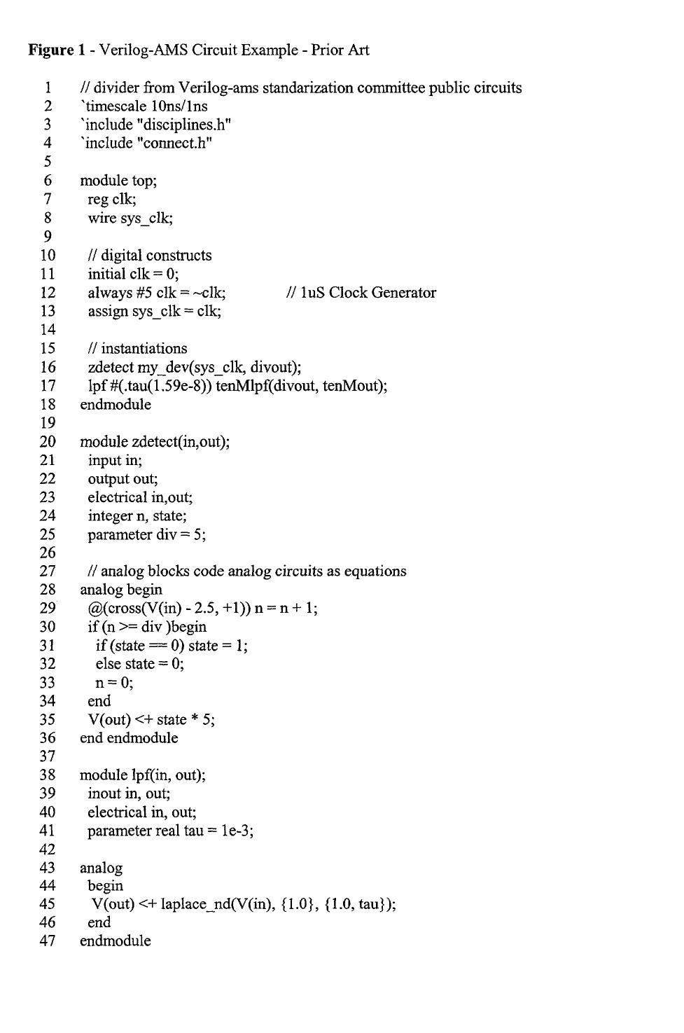

### DESCRIPTION OF THE PREFERRED EMBODIMENTS

In accordance with the principles of the present invention, a PLI API based analog mixed signal (AMS) electronic system simulation system and method is disclosed. In its preferred embodiment, the system and method simulates designs coded in a standardized mixed signal HDL such as Verilog-AMS or VHDL-AMS. In an alternative embodiment a number of different analog and digital HDLs are simulated. The HDL may be of a human readable form or non-human readable form such as binary data inside a computer memory.

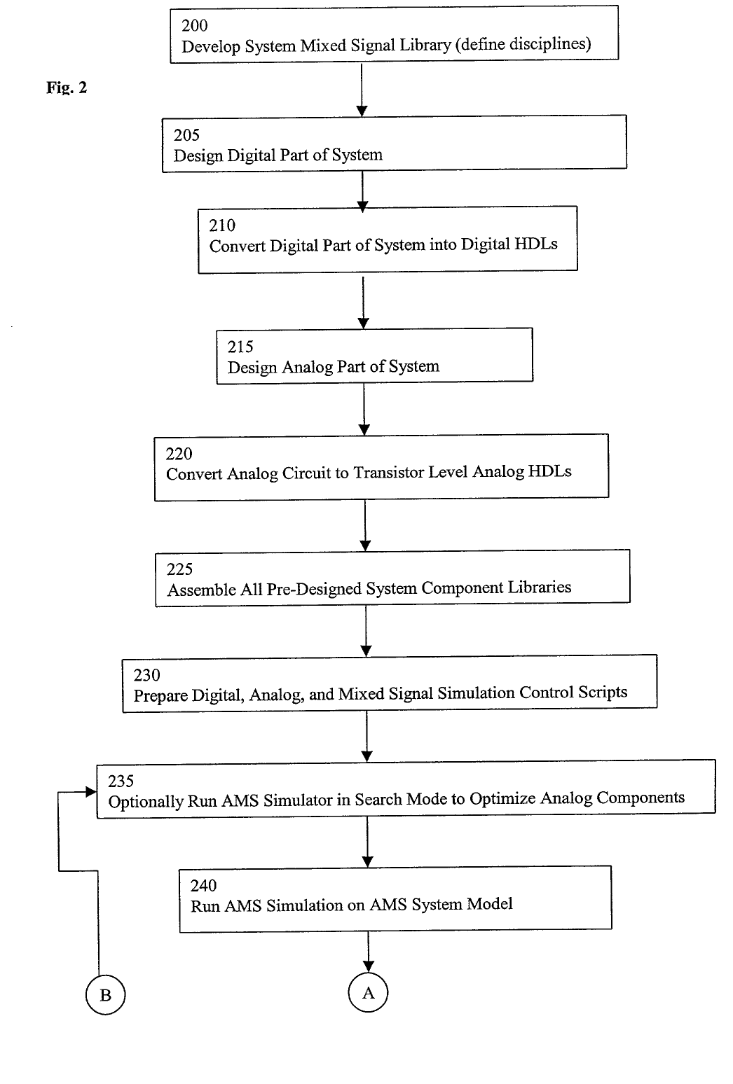

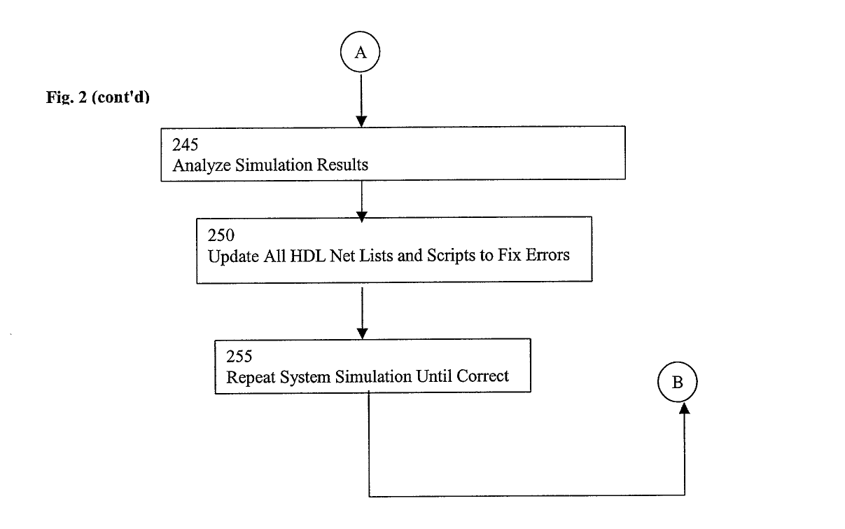

Referring to FIG. 2, a flowchart showing mixed signal system design flow enabled by the present invention is shown. As shown in boxes 205, 210, 225, and 230 for digital design, and 215, 220, 225 and 230 for analog design, design flow starts with conventional analog and digital design. As shown in block 200, the mixed signal library for the system is developed and disciplines are defined. Per function block 205, the digital portion of the mixed signal system is designed and then converted into one or more digital HDL descriptions per function block 210. Per function block 215, the analog portion of the mixed signal system is designed and then converted to one or more transistor level analog HDLs per function block 220. Per function block 225, all pre-designed mixed signal system component libraries are assembled, and per function block 230 the digital, analog and mixed signal control scripts are prepared.

Next, per function block 235, due to the flexibility of the PLI method disclosed herein, the present invention can be used to perform analog component optimization. Analog component properties are optimized using repeated AMS simulations under control of both analog and digital simulation control scripts. The scripts contains programs that control the selection of circuit parameters that are optimized, the range over which searching is performed (usually called parameter sweeping in the art), and optimization success criteria. Although such component optimization has been previously used in analog simulation, the PLI based method disclosed herein allows both digital and analog state to be used in the optimization process. Once common use of this analog design space search capability is for optimization of AtoD and DtoA component properties. Commonly optimized are the size of resistors, size of capacitors, transistor driver and circuit stability.

Function blocks 240, 245 and 250 show the process of simulating the AMS system model, analyzing the simulation results, and then fixing bugs (e.g., all HDL net lists and scripts are updated to fix errors). After which, a verification cycle may be repeated if there were errors. Per function block 255, the control flow goes back to function block 235 during an optimization run or to function block 240 during a verification run. This cycle is similar to simplified current digital verification and avoids complex design flow requiring separate analog and digital simulation followed by comparing and inspecting different types of simulation results.

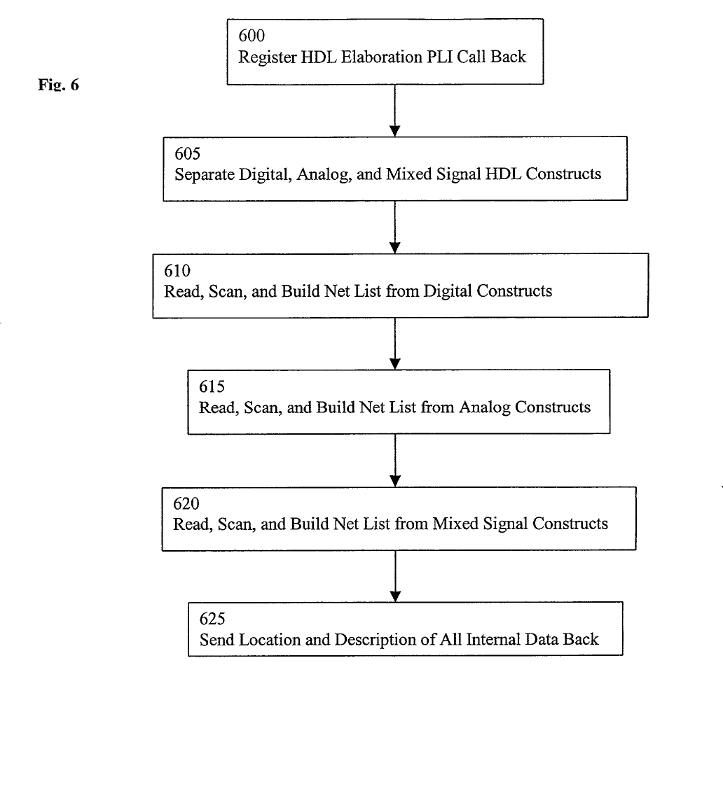

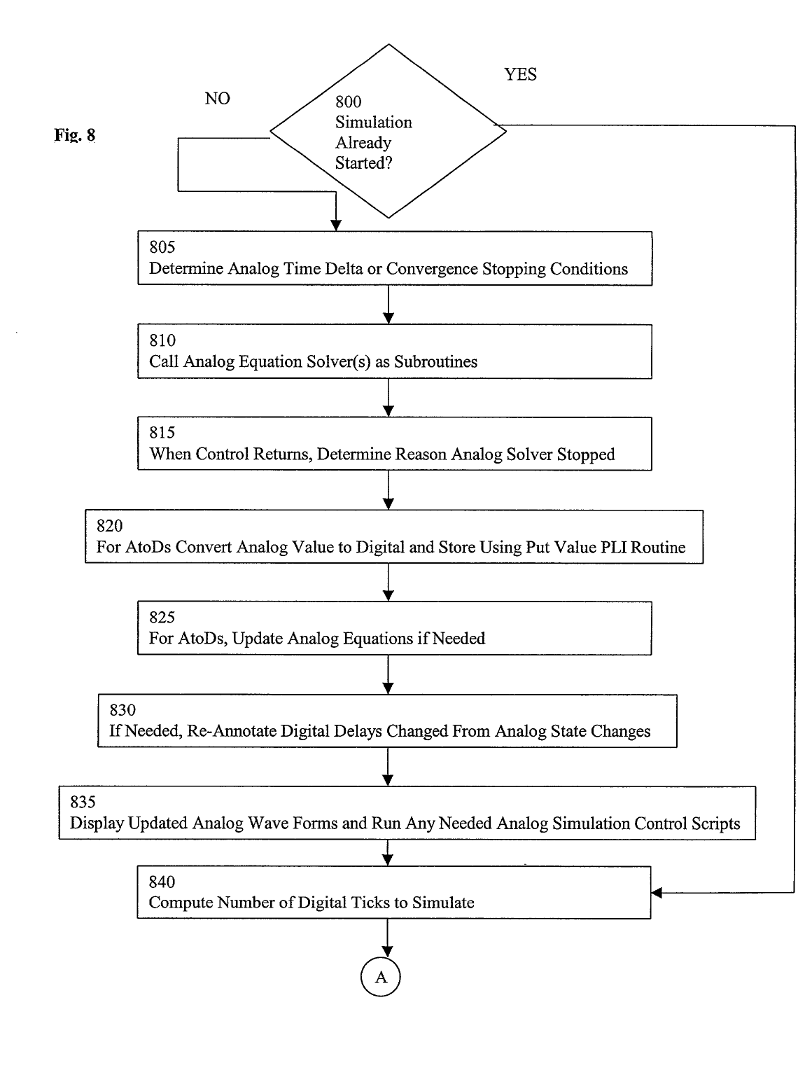

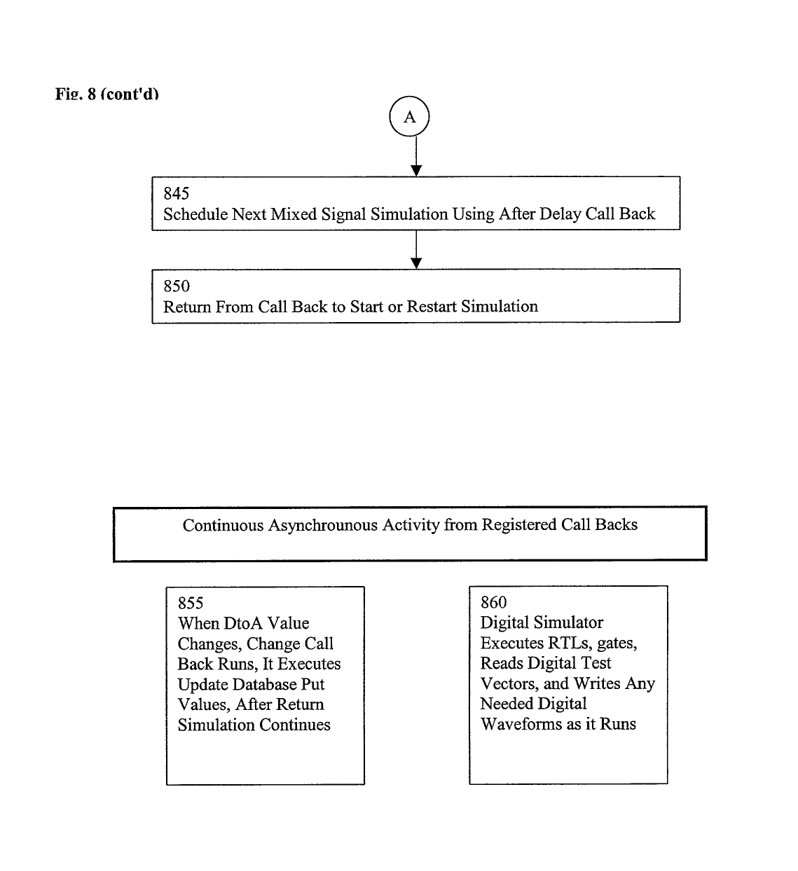

An important organizing principle of PLI API based systems is that they function primarily through call backs. Call back synchronization provides the functionality needed for synchronizing discrete digital time units with continuous analog wave forms defined in terms of differential equations (see FIG. 8). Call backs provide access and timing for AtoD and DtoA interfaces. In addition, the PLI call back mechanism allows PLI scanning of elaborated digital and analog design databases to determine locations where analog and digital interaction occurs (see FIG. 6).

In the present invention, the mixed signal engine registers PLI call backs that are “called” by one or a plurality of digital simulators according to the call back reason. Because HDL simulator PLIs already provide much of the functionality needed by the mixed signal engine, the operation of the present invention is simplified compared to monolithic kernel AMS simulators.

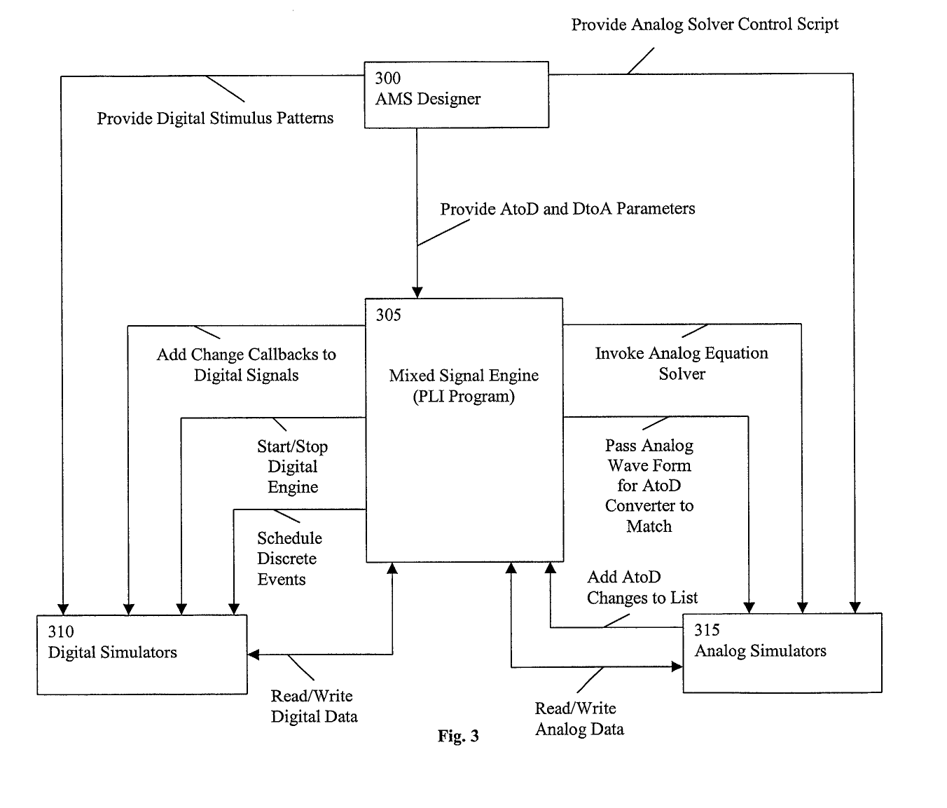

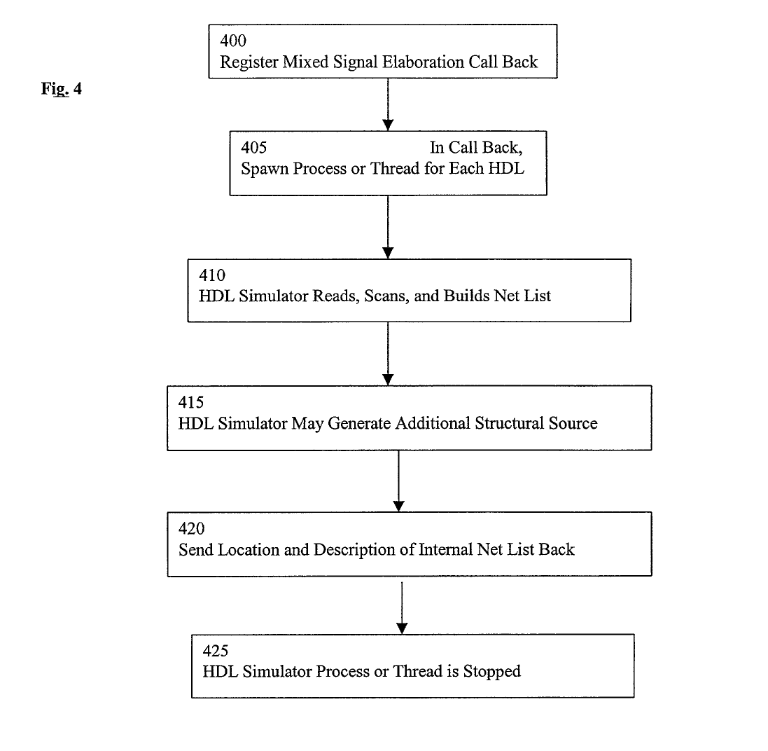

Referring now to FIG. 3. an overview of AMS simulator organization is provided and includes reference to an AMS designer 300 as well as the main components, i.e., the AMS simulation engines, mixed signal engine 305, a digital simulator 310 (digital engine), and an analog simulator 315 (analog engine). The digital simulator 310 may be any conventional digital simulator. Because digital HDLs are standardized, any of many brands and types of digital simulators can be used. The analog simulator 315 may be any conventional analog circuit simulator. Currently, Spice is the most common analog simulator although simulators for the Verilog A analog HDL are also used. The mixed signal PLI program 305 is the mixed signal coordinating program that uses the PLI to implement mixed signal simulations as shown in FIGS. 4 through 8.

The various bi-directional arrows connecting the components and connecting the AMS designer illustrate the information flow between the various AMS simulation components. Specifically, the AMS designer 300 provides the digital stimulus patterns to the digital simulator(s) 310, provides the analog solver control script(s) to the analog simulator 315, and provides the AtoD and DtoA parameters to the mixed signal program 305. The mixed signal program 305 interfaces with the digital simulator(s) 310 by adding change call backs to digital signals, starting and stopping the digital simulation, scheduling discrete events as well as reading and writing digital data to and from the digital simulator(s) 310. The mixed signal program interfaces with the analog simulator(s) 315 by invoking the analog equation solver and passing analog wave form patterns that must be matched to determine an AtoD converter digital logic value, as well as reading and writing analog data to and from the analog simulator(s) 315. The analog simulator(s) 315 additionally operate to add AtoD changes to the net list of the mixed signal program 305.

FIG. 3 depicts the PLI call back based sequencing mechanism of the present invention. Here, simulators and mixed signal procedures run freely. When an event or action occurs, a call back is called and the mixed signal engine 305 (or parallel thread of mixed signal engine) stops until control is returned from the call back. The mixed signal engine 305 (here located in mixed signal after delay call back) then continues alternatively executing digital simulation for a period and then analog simulation for a period. The PLI organization disclosed here requires use of some kind of parallel execution mechanism such as processes or threads only in embodiments including more than one analog or more than one digital simulator.

Before AMS simulation can start, digital and analog HDL components must be elaborated. FIG. 4 lists the steps each digital simulator executes for elaboration of its HDL and each analog simulator executed for elaboration of its HDL. The elaboration process is substantially similar for both. FIG. 4 shows elaboration for the embodiment in which more than one digital or more than one analog HDL are used. The steps of elaboration include registering mixed signal elaboration call backs, per function block 400. Then, in the call backs, spawning a process or thread for each HDL, per function block 405. The HDL simulator (digital or analog) then reads, scans and builds its net list, per function block 410. The HDL simulator may then generate additional structural source code, per function block 415. The locations and descriptions of the internal net lists of the digital and analog simulators are then passed back to the mixed signal engine, per function block 420 and the HDL simulator process or thread is stopped, per function block 425. While digital elaboration and analog elaboration are quite similar it should be noted that digital elaboration involves procedural RTL and gates while analog elaboration involves transistor bodies and analog block equation descriptions.

In the preferred embodiment, the circuit net list descriptions created during digital and analog elaboration are stored separately and later accessed by the mixed signal engine. As described in functional block 420, the elaborated circuit description data base access information is passed back to the mixed signal engine. In an alternative embodiment, one unified database is used. In this alternative embodiment functional block 420 would be replaced by a step that sends all elaborated digital net list data base information back to the mixed signal engine so that the mixed signal engine may add the data to the unified data base.

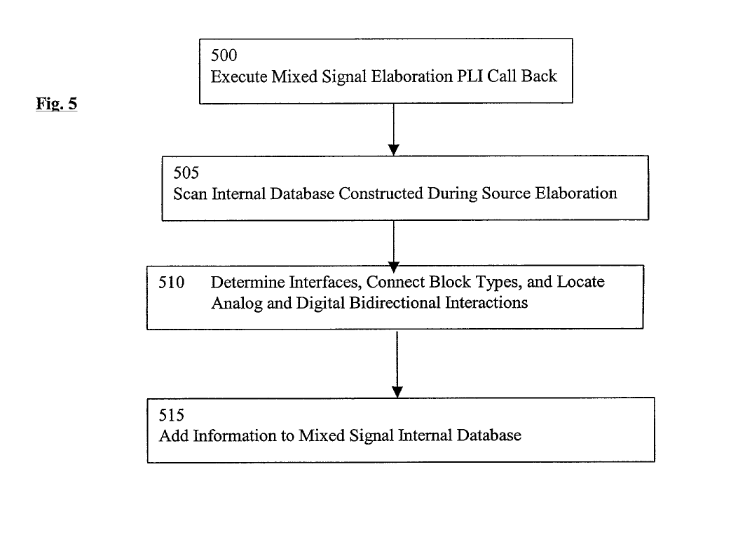

Referring to FIG. 5, after separate digital and analog elaboration are completed, mixed signal elaboration PLI call backs are executed, per function block 500. The constructed net list databases are scanned again to elaborate any mixed signal interfaces, per function block 505, as well as analog effects in digital components and digital effects in analog components, per function block 510. The types of digital and analog interaction that must be elaborated are: determining locations for inserting DtoAs and AtoDs (normally called connect block insertion), elaborating final values of parameters shared by digital and analog components, determining analog equation changes from digital connections, back annotating digital delay values (normally using standardized SDF format) and back annotating analog parametrics (usually using standardized SPF format). The mixed signal elaboration data is then added to the mixed signal internal database, per functional block 515.

It should be noted that an AMS design consists of a unified instance tree. If the instance tree database format is the same for both analog and digital HDLs, no additional elaboration is required to construct AMS design instance tree. Otherwise, during mixed signal elaboration the analog and digital instance trees are combined into a unified instance tree. In a possible alternative embodiment mixed signal elaboration can work by generating new digital and analog HDL source that is then elaborated by repeating HDL elaboration for new “mixed signal” components (refer to FIG. 4).

FIG. 6 shows the elaboration steps for an alternative embodiment wherein only one AMS HDL is used. The elaboration steps include: registering HDL elaboration PLI call backs, per function block 600; separating digital, analog, and mixed signal HDL constructs, per function block 605; reading, scanning, and building a net list from digital constructs, per function block 610; reading, scanning, and building a net list from analog constructs, per function block 615; reading, scanning. and building a net list from mixed signal constructs, per function block 620; and sending the location and description of all internal data back to the mixed signal engine, per function block 625. When only one AMS HDL is used, all three of analog, digital, and mixed signal constructs are elaborated simultaneously. AMS HDLs simplify mixed signal elaboration because mixed signal constructs are coded in the HDL, although some additional rescanning of the AMS HDL database is still required. Otherwise, the steps in FIG. 6 are predominantly the same as those in FIG. 4 (non-unified AMS HDL). Currently, even when only one unified AMS HDL is used, a mechanism to include legacy Spice net lists is needed for AMS system simulation. AMS HDLs define a “foreign” language include mechanism that allows Spice net lists to be included in the AMS HDL source. In the preferred embodiment, Spice is processed by registering an “include different language” call back. A normal Spice elaborator is then used to translate Spice into the AMS HDL analog block construct inside that call back. In an alternative embodiment, the analog simulator is modified to also solve equations from included non-native HDL languages.

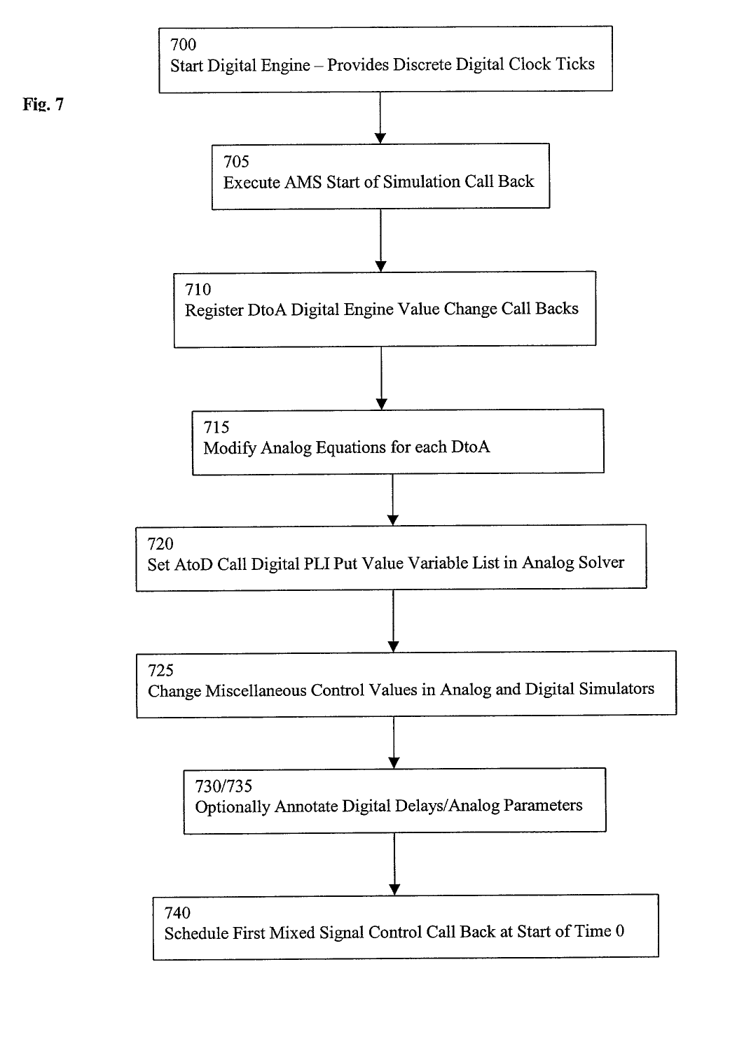

Before AMS simulation can begin, the various PLI call backs needed for mixed signal interaction must be registered. Because multiple PLI applications must co-exist, the first step in execution of simulation using a PLI requires that a number of call back routines are registered by placing them in a table. This table is one of first things executed by the mixed signal simulation program when it starts running (exact details are defined as part of PLI specification). One elaboration routine needs to be registered for each HDL that needs elaborating (refer to FIGS. 4, 5 and 6) and one call back must be registered at the start of simulation (conceptually, the first action is at time 0). FIG. 7 details the steps executed in an AMS simulation set up call back wherein the digital engine has been started, per function block 700. Note that FIG. 7 assumes that the steps in it are being executed in a “start of simulation” call back, per function block 705.

Per function block 710, the elaborated mixed signal data base is accessed and all port instance locations where the input side of a port is digital and the other side connects to a port of a component modeled as analog transistors or equations are found. For each such port, a value change call back is registered to monitor changes in the connected digital net. For digital HDL's supporting vectors of signals, one call back is registered for each bit of a vector. For AMS HDLs such as Verilog-AMS, different types of AtoD converters are needed. If no DtoA converter is defined for the port, a default connect block defined DtoA converter is used. In the preferred embodiment, a different call back processing routine is registered for each different type of DtoA converter, but in an alternative embodiment, only one call back routine is registered. Here, the call back processing routine accesses the design database to determine the type of DtoA converter processing needed. There may also be a need to associate analog equations with call backs as shown in function block 715.

Per function block 720, the elaborated mixed signal database is accessed and all port instance locations where the input side of a port is analog and the other side connects to a port of a component modeled digitally are found. For each port, a list of digital values that must be updated at the end of each analog conversion step is recorded (refer to FIG. 8 for a description of how this list is used). As shown in function block 725, both digital and analog simulators must be initialized. This may require analysis of the AMS database to determine, for example, the maximum analog time step needed. Or, it may involve running pattern preparation scripts for digital or running mathematical modeling scripts to properly initialize the analog side depending on how the user sets up the simulation control scripts.

As shown in function block 730/735, in the preferred embodiment during simulation set up, delay annotation of digital delays using SDF file reading annotation and analog parametrics using SPF file reading annotation occurs. Because designers often prefer conditional annotation depending on conditions coded in HDLs, in alternative embodiments annotation may occur during simulation. For this embodiment, “end of annotation action” call backs are registered to update analog equations and state, and digital state. In another alternative embodiment, annotation is only allowed during mixed signal elaboration. This embodiment allows more efficient simulation because values can be compiled into simulation models, but it is the least popular with designers because it is less flexible.

As shown in function block 740, the final step in simulation set up is scheduling “first end of digital time advance simulation” call back. In the preferred embodiment, digital simulation runs before analog simulation and an “end of time advance” fence event is used to stop the digital time movement and run the analog solvers (see FIG. 8 for steps executed in simulation call back). The first “end of time advance” call back is either scheduled at the end of time 0 or is scheduled using the normal digital time advance amount. The amount of time to advance between digital simulation time advance and analog simulation time advance is usually called time delta. For the special cases of all or almost all analog in design (usually called big A small D), the analog simulator runs as normal after the first end of time advance event because digital delta can be adjusted to occur at the end of the simulation period. For the special cases of all or almost all digital in design (usually called big D small A), the digital simulator runs as normally except for one added end of time advance call back executed after each digital delta that is very efficient and simple because it does not need to call analog solvers.

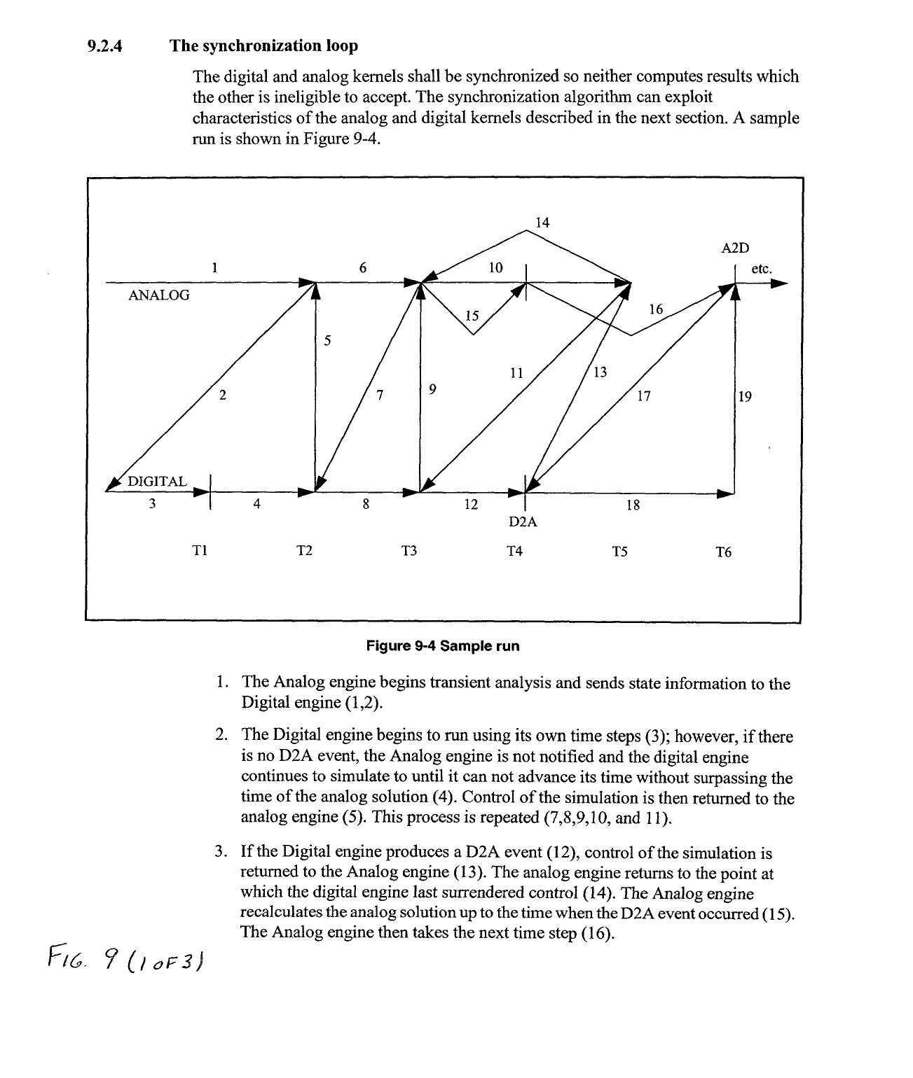

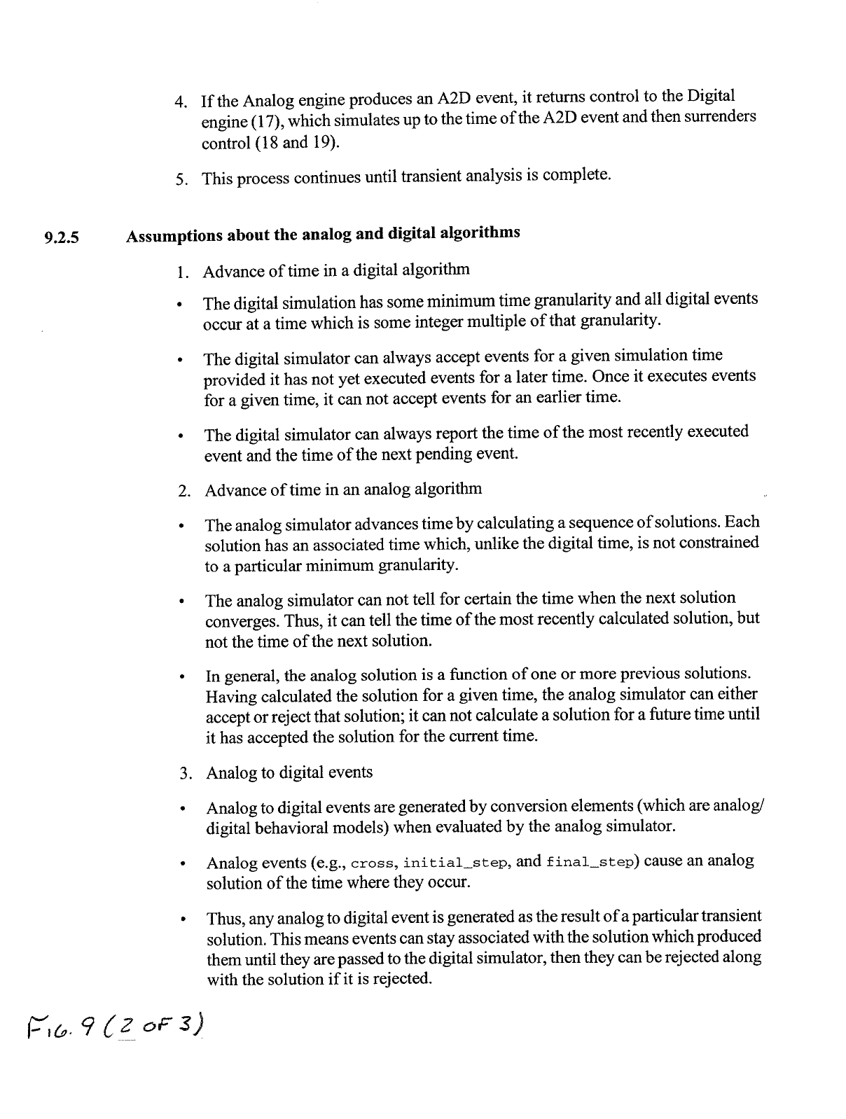

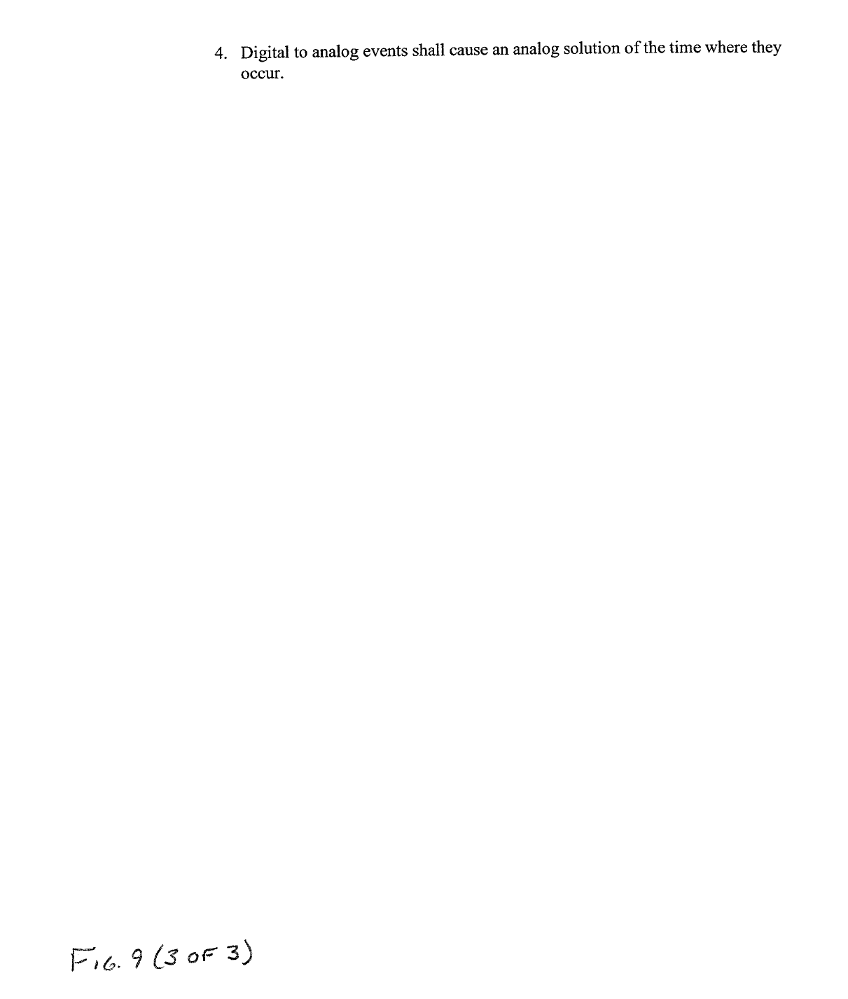

Referring to FIG. 8, it can be seen that the main control and synchronization simulation steps of this PLI based AMS simulation per the present invention occur in “end of digital time advance” call backs. The call backs are similar to an alarm clock that triggers after a certain duration of time has elapsed. The steps in FIG. 8 are executed in that call back after digital discrete event time reaches the end of the digital time step. The preferred embodiment described in FIG. 8 uses time movement and the AMS synchronization method defined in sections 9.24 and 9.25 of the Verilog-AMS LRM draft 1.5, which are hereby incorporated by reference and provided as FIG. 9 (pages 1-3). Verilog-AMS and this synchronization method are currently still being refined. When the draft standard is completed, it will be submitted to IEEE to be approved as a standard. Other synchronization methods are used in other embodiments of this invention and since continuous analog and discrete digital time synchronization is being researched, future embodiments may use newly discovered synchronization methods. Because HDL PLIs allow full computer program generality, any such method is realizable using the PLI system and method disclosed herein.

As shown in function block 810, after digital time movement completes and the analog time delta or convergence stopping conditions have been determined, per function block 805, the analog solvers are called and run to convergence, or to an upper time limit band, so that analog time catches up with the digital time. When all analog solvers complete (return from call back in embodiment using only one solver), as shown in function block 815, the reason for all analog solvers return is analyzed. Information computed per function block 815 is used to compute the amount of digital time to move for the next digital delta, as shown in function block 840. Next as shown by function block 820, the list of AtoD analog nodes saved in FIG. 7, function block 720, is traversed to determine which signals have changed logic values. Usually logic value changes occur when particular voltage thresholds are passed or when AMS HDL conditions programmed by the user are satisfied. Function block 825 shows other processing that is needed in preparation for the next analog solvers invocation.

Function block 830 shows an optional step, i.e., re-annotating digital delays changed from analog states changes that increases modeling accuracy. It is possible that an analog circuit state can change digital delays (probably due to capacitive effects); digital delays are then changed by calling digital HDL PLI put delay routines. In function block 835, any displayed analog wave forms are updated and any analog control or checking scripts are executed. Mathematical packages such as MATLAB® are run to calculate analog convergence or other analog state properties that can then be used to end or change AMS simulation.

Starting with function block 840, the operations that prepare for the next digital simulation step are executed. Notice that decision block 805 is used to skip analog time movement for (usually time 0) call back execution. This is needed because in the preferred embodiment digital time moves before analog time, but in other embodiments analog time could move first. Function blocks 805 through 835 are skipped in preferred embodiment.

As shown in function block 840, the digital time at which to schedule the next AMS simulation call back is computed. The computation uses the results from the previous analog solver shown in function block 815. As shown in function block 845, the next digital simulation “end of time advance” call back is registered. The call back then completes and control returns from the call back, per function block 850.

Function blocks 855 and 860 occur asynchronously during operation of the present invention, i.e., whenever a DtoA input digital event occurs the call back referred to in block 855 is called, executes, and then returns, and whenever the digital simulator starts it runs until it is instructed to stop and execute a call back routine. As shown in box 855, whenever value change call backs registered on a DtoA input port (as seen in FIG. 7, function block 710) occur because a digital value changed, the digital value is converted to an analog node value and the analog data and equations are updated. A more efficient embodiment would save all DtoA input changes and process them at end of digital simulation period. This reduces amount of processing needed when a digital value changes to new value and then changes back to a starting value. As shown in function block 860 during digital simulation digital wave form displays are updated and procedural HDL is run to test for digital simulation completion. Digital values are displayed dynamically because the internal digital state is always correct, however for analog, the correct state may only occur at equation convergence points.

Other embodiments of the invention disclosed here that simulate analog circuits using circuit values other than voltage are also possible. Normal analog simulation uses transistor node voltages, but other analog circuit values such as frequency, current, or magnetic field strength can also be described using differential equations and solved to implement other types of analog simulation providing the value still has a time domain component. In these other embodiments AMS simulation remains the same except AtoD and DtoA operations are changed to map between different analog circuit properties and digital logic values. In some of these other embodiments, conversion may require extensive computation.

It should be noted that the flowcharts described above present a preferred direction of flow of control. However, the sequence of steps performed and/or the simultaneity of the steps performed under the present invention may be altered without departing from the spirit or scope of the invention.

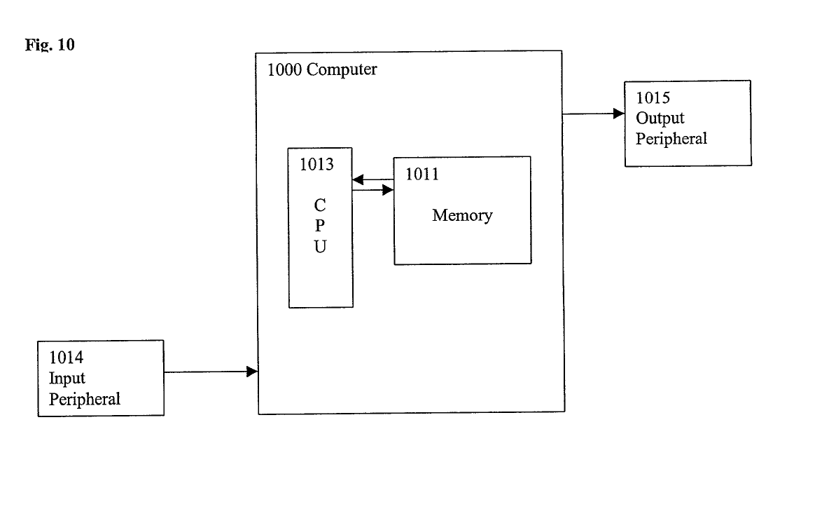

The present invention is preferably realized through use of a computer system, an example of which is provided in FIG. 10. The computer system of FIG. 10 includes a computer 1000 having a central processing unit 1013 and memory 1011 for execution of program instructions of the present invention. Input peripherals 1014 as well as output peripherals 1015 may be utilized with the computer system.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A system for simulating a circuit having both digital and analog components, wherein at least a portion of said circuit has been coded into a hardware description language (HDL) model, comprising:
a digital simulator that utilizes a programming language interface (PLI), wherein said digital simulator produces digital circuit information based on said HDL model;
an analog simulator that utilizes said PLI, wherein said analog simulator produces analog circuit information based on said HDL model; and
a mixed signal program that utilizes said PLI, that controls said digital and analog simulator, and that synchronizes a discrete digital time and a continuous analog time, wherein the use of said PLI by all three of said digital simulator, said analog simulator, and said mixed signal program comprises a mixed signal engine.

2. The system of claim 1, wherein said digital simulator includes an elaborator, wherein said elaborator converts a digital portion of a circuit net list description into an internal digital and instance structure database within said digital simulator, and wherein said analog simulator includes an elaborator, wherein said elaborator converts an analog portion of a circuit net list description into an internal database within said analog simulator.

3. The system of claim 2, wherein said mixed signal program operates to read the digital simulator database and transfer the digital simulator database to said analog simulator, wherein said mixed signal program operates to read the analog simulator database and transfer the analog simulator database to said digital simulator, and wherein said mixed signal program utilizes the read data within the digital simulator database and the analog simulator database to perform a mixed signal interface processing function.

4. The system of claim 1, wherein said digital simulator includes an event engine to schedule a discrete time digital event.

5. The system of claim 1, wherein said analog simulator includes an analog circuit equation solver.

6. The system of claim 1, further comprising a time synchronizer that enables said mixed signal engine to schedule a PLI call back, wherein said PLI call back stops a digital simulation by said digital simulator so that said continuous analog time can advance to said discrete digital time or can move to a synchronization point.

7. The system of claim 1, further comprising a time synchronizer that enables said mixed signal engine to return from a PLI call back, wherein upon returning from said PLI call back, said digital simulator is advanced enabling said discrete digital time to advance to said continuous analog time or can move to a synchronization point.

8. The system of claim 1, further comprising a digital value changer that enables said mixed signal engine to schedule a value change call back on a digital signal, wherein upon a change in said digital signal said value change call back enable said mixed signal engine to change said digital signal to an analog value.

9. The system of claim 1, further comprising an analog to digital converter that enables said mixed signal engine to determine a digital value from an analog wave form pattern.

10. The system of claim 1, further comprising a digital to analog converter that enables said mixed signal engine to determine an analog value from a digital value.

11. The system of claim 1, wherein said digital simulator maintains a digital database and said analog simulator maintains an analog database, and wherein said mixed signal engine is able read a value from and write a value to said digital database and said analog database.

12. The system of claim 11, wherein the writing of said mixed signal engine to said digital database or said analog database provides for simulation control.

13. The system of claim 12, wherein said simulation control comprises a digital control script.

14. The system of claim 12, wherein said simulation control comprises an analog control script.

15. A method of analog mixed signal simulation for simulating a circuit, having both digital and analog components that is described by one or more hardware description languages (HDLs), comprising the steps of:
reading the HDL;
elaborating the HDL for said digital components of said circuit;
elaborating the HDL for said analog components of said circuit;
performing a mixed signal elaboration on the HDL to determine digital and analog interaction locations;
performing a mixed signal initialization after said mixed signal elaboration; and
executing mixed signal simulation based on said mixed signal initialization wherein said step of executing includes digital simulation, analog simulation, and the synchronizing of a timing of said digital simulation with a timing of said analog simulation,
wherein each of the above steps are implemented at least in part by using a programming language interfaces (PLIs).

16. The method of claim 15, wherein said step of elaborating the HDL for said digital components comprises creating a digital circuit net list description and converting said digital net list description into a digital and instance structure database and wherein said step of elaborating the HDL for said analog components comprises creating an analog circuit net list and converting said analog circuit net list into a database.

17. The method of claim 16, wherein said step of performing a mixed signal initialization includes reading the digital database and enabling said analog simulation to utilize data within said digital database, includes reading the analog database and enabling said digital simulation to utilize data within said analog database, and includes utilizing said data within said digital database and said analog database to perform mixed signal processing.

18. The method of claim 15, wherein said step of executing mixed signal simulation includes scheduling a discrete time digital event.

19. The method of claim 15, wherein said step of executing mixed signal simulation includes solving an analog circuit equation.

20. The method of claim 15, wherein said step of executing mixed signal simulation includes performing digital simulation.

21. The method of claim 5, wherein said step of executing mixed signal simulation includes scheduling a PLI call back, wherein said PLI call back stops a digital simulation enabling said timing of said analog component to advance to said timing of said digital component or to a pre-determined synchronization time.

22. The method of claim 15, wherein said step of executing mixed signal simulation includes returning from a PLI call back, wherein upon returning from said PLI call back, said timing of said digital component is advanced enabling said timing of said digital component to advance to said timing of said analog component or to a pre-determined synchronization time.

23. The method of claim 15, wherein said step of executing mixed signal simulation includes scheduling a value change call back based on a digital signal, wherein upon a change in said digital signal said value change call back enables the changing of said digital signal to an analog value.

24. The method of claim 15, wherein said step of executing mixed signal simulation includes determining a digital value from an analog wave form pattern.

25. The method of claim 15, wherein said step of executing mixed signal simulation includes determining an analog value from a digital value.

26. The method of claim 15, wherein said step of executing mixed signal simulation includes reading a value from and writing a value to a digital simulation database and an analog simulation database.

27. The method of claim 26, wherein writing a value to said digital simulation database or said analog simulation database provides for control of the execution of said mixed signal simulation.

28. The method of claim 27, wherein said value comprises a digital control script.

29. The method of claim 27, wherein said value comprises an analog control script.

30. A system for simulating a circuit having both digital and analog components, wherein at least a portion of said circuit has been coded into a hardware description language (HDL) model, said system comprising:
reading means for reading the HDL;
first elaborating means for elaborating the HDL for said digital components of said circuit:
second elaborating means for elaborating the HDL for said analog components of said circuit;
third elaborating means for performing a mixed signal elaboration on the HDL to determine digital and analog interaction locations;
initializing means for performing a mixed signal initialization after said mixed signal elaboration; and
executing means for executing mixed signal simulation based on said mixed signal initialization wherein said executing means includes a digital simulation means for performing digital simulation, analog simulation means for performing analog simulation, and synchronizing means for synchronizing a timing of said digital simulation with a timing of said analog simulation,
wherein each of the above means utilizes a programming language interface (PLI).

31. The system of claim 30, wherein said first elaborating means includes means for creating a digital circuit net list description and means for converting said digital net list description into a digital and instance structure database, and wherein said second elaborating means includes means for creating an analog circuit net list and means for converting said analog circuit net list into a database.

32. The system of claim 31, wherein said initializing means includes means for reading the digital database and means for enabling said analog simulation means to utilize data within said digital database, includes means for reading the analog database and means for enabling said digital simulation means to utilize data within said analog database, and includes means for utilizing said data with said digital database and said analog database to perform mixed signal processing.

33. The system of claim 30, wherein said executing means includes a means for scheduling a discrete time digital event.

34. The system of claim 30, wherein said executing means includes a means for solving an analog circuit equation.

35. The system of claim 30, wherein said executing means includes a means for performing digital simulation.

36. The system of claim 30, wherein said executing means includes a means for scheduling a PLI call back, wherein said PLI call back stops a digital simulation enabling said timing of said analog simulation to advance to said timing of said digital simulation or to a pre-determined synchronization time.

37. The system of claim 30, wherein said executing means includes a means for returning from a PLI call back, wherein upon returning from said PLI call back, said timing of said digital simulation is advanced enabling said timing of said digital simulation to advance to said timing of said analog simulation or to a pre-determined synchronization time.

38. The system of claim 30, wherein said executing means includes means for scheduling a value change call back based on a digital signal, wherein upon a change in said digital signal said value change call back enables the changing of said digital signal to an analog value.

39. The system of claim 30, wherein said executing means includes a means for determining a digital value from an analog wave form pattern.

40. The system of claim 30, wherein said executing means includes a means for determining an analog value from a digital value.

41. The system of claim 30, wherein said executing means includes a means for reading a value from digital simulation database or an analog simulation database, and a means for writing to a digital simulation database or an analog simulation database.

42. The system of claim 41, wherein writing a value to said digital simulation database or said analog simulation database provides execution control for said execution means.

43. The system of claim 42, wherein said value comprises a digital control script.

44. The system of claim 42, wherein said value comprises an analog control script.
